(19) United States
(12) Patent Application Publication
(10) Pub. No.: US 2004/0143982 A1
(43) Pub. Date: Jul. 29, 2004

(54) Rolling square

(76) Inventor: Robert O. Braun JR., Punta Gorda, FL (US)

Correspondence Address: POLSINELLI SHALTON & WELTE, P.C., 700 W. 47TH STREET, SUITE 1000, KANSAS CITY, MO, 64112-1802, US

(21) Appl. No.: 10/722,151

(22) Filed: Nov. 25, 2003

Related U.S. Application Data
(60) Provisional application No. 60/430,198, filed on Dec. 2, 2002.

(51) Int. Cl. B43L 7/00

(52) U.S. Cl. 33/429

(57) ABSTRACT

A single tool for facilitating any or all of marking, scoring or cutting building materials, for example, planar building materials, including drywall, sheetrock, plywood, paneling, siding, insulation board and laminates, includes a head that receives a body. The head includes lateral sides that extend beyond the body, each of these sides typically having at least two wheels. The body includes an edge, oriented perpendicular to both the head and the plane formed by the tangents of the lowest points of the wheels. This edge includes notches at intervals along it, for receiving instrumentation for the aforementioned marking, scoring or cutting of planar building materials.

### CROSS REFERENCES TO RELATED APPLICATIONS

This application is related to and claims priority from U.S. Provisional Patent Application Serial No. 60/430,198, filed Dec. 2, 2002, entitled: ROLLING SQUARE. U.S. Provisional Patent Application Serial No. 60/430,198 is incorporated by reference herein.

### TECHNICAL FIELD

The present invention is related to apparatus for marking, scoring and cutting building materials. In particular, the present invention provides an apparatus for facilitating marking, scoring and cutting of planar building materials.

### BACKGROUND

The use of basic building materials, such as planar materials, for example, drywall, sheetrock, plywood, paneling, siding, insulation board and laminates, is commonplace in construction jobs. Typically, large amounts of these materials are needed, and different tools are needed for preparing these materials for the specific location where they will be used.

Preparation of these materials requires that they be marked, scored and ultimately cut, to fit the specific location where they will be used. These tasks involve using multiple tools, one for the marking, another for the scoring, and yet another for the cutting. Use of three separate tools for these three different tasks is simply inefficient and time consuming. Moreover, each separate task typically involves making measurements multiple times for each job. This adds further time to the job and increases the chances of material waste from a measurement error.

### SUMMARY

The present invention improves on the contemporary art by providing a single tool for facilitating any or all of marking, scoring or cutting building materials, for example, planar building materials, including drywall, sheetrock, plywood, paneling, siding, insulation board and laminates. As a result of a single apparatus being used, measurements are consistent, and substantial amounts of time are saved, as the processes of marking, scoring and cutting have been consolidated.

The present invention provides a single tool or apparatus for facilitating any or all of marking, scoring or cutting building materials, for example, planar building materials, including drywall, sheetrock, plywood, paneling, siding, insulation board and laminates. It includes a head that receives a body. The head includes lateral sides that extend beyond the body, each of these sides typically including at least two wheels. The body includes an edge, oriented perpendicular to both the head and the plane formed by the tangents of the lowest points of the wheels. This edge includes notches at intervals along it, for receiving instrumentation for the aforementioned marking, scoring or cutting of planar building materials. The apparatus is typically symmetric for both right-handed and left-handed use.

An embodiment of the present invention is directed to an apparatus for operating on at least substantially planar materials. This apparatus includes a body having at least one edge configured for temporarily accommodating instrumentation for at least one of marking, cutting or scoring, a head in communication with the body, the head including at least one lateral portion extending beyond the body; and, at least two rollers along the at least one lateral portion. The rollers are oriented substantially coplanar to each other to define a first plane. This first plane is typically perpendicular to the longitudinal axis of the body, and in particular, to the at least one edge configured for temporarily accommodating the aforementioned instrumentation.

Another embodiment of the invention is directed to an apparatus for operating on at least substantially planar materials. This apparatus includes a body having at least one edge, typically, one edge, configured for temporarily accommodating instrumentation for at least one of marking, cutting or scoring; a head attached to at least a portion of body, the head including at least one lateral portion extending beyond the body; and at least two rollers, for example, wheels, along the at least one lateral portion. The rollers are oriented substantially coplanar to each other to define a first plane. This first plane is typically perpendicular to the at least one edge configured for temporarily accommodating the aforementioned instrumentation.

Another embodiment of the invention is directed to a method for operating on at least substantially planar materials. This method includes, providing an apparatus including, a body having at least one notch along an edge, the notch for temporarily accommodating instrumentation for at least one of marking, cutting or scoring; a head in communication with the body, the head including at least one lateral portion extending beyond the body; and at least two rollers along the at least one lateral portion, the rollers oriented substantially coplanar to each other to define a plane. This plane is typically at least substantially perpendicular to the plane defined by the edge of the body that includes the at least one notch. The rollers of the at least one lateral portion are then placed into contact with the top surface of an at least substantially planar material. An instrument for at least one of marking, scoring or cutting is provided into the at least one notch, and into contact with the material. The apparatus is moved along the top surface of the at least substantially planar material, resulting in a mark, score or cut in the material.

### BRIEF DESCRIPTION OF THE DRAWINGS

Attention is now directed to the drawing figures, where like numerals or characters indicate corresponding or like components. In the drawings:

FIG. 1 is a side view of an apparatus in accordance with the present invention;

FIG. 2 is a bottom view of the apparatus taken along the plane HH of FIG. 1;

FIG. 3 is a front view of the apparatus of FIG. 1;

FIG. 4 is a rear view of the apparatus of FIG. 1;

FIG. 5 is an exploded side view of the apparatus of FIG. 1 with the wheels removed;

FIG. 6A is a side view of the apparatus of the invention in a right-handed use;

FIG. 6B is front view of the apparatus in FIG. 6A;

FIG. 6C is a rear view of the apparatus in FIG. 6A;

FIG. 7 is a side view showing a right-handed use of the apparatus of the invention; and

FIGS. 8A and 8B are side views showing a left-handed use of the apparatus of the invention.

### DETAILED DESCRIPTION OF THE DRAWINGS

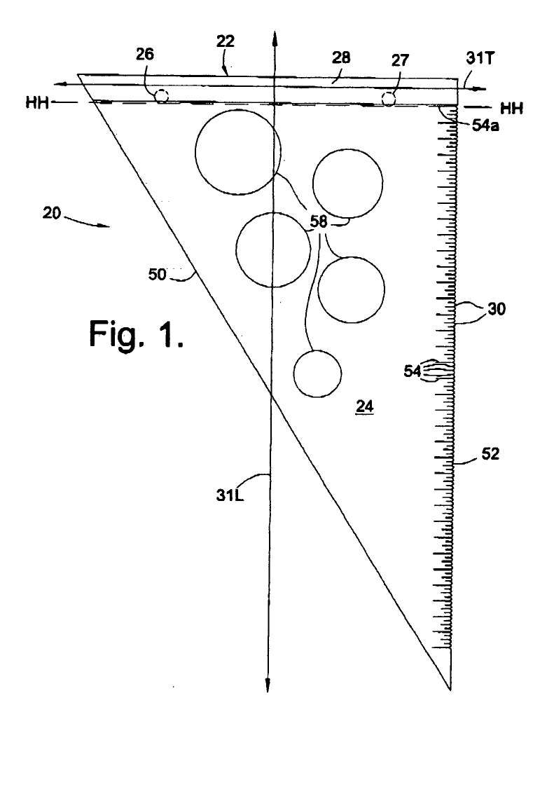

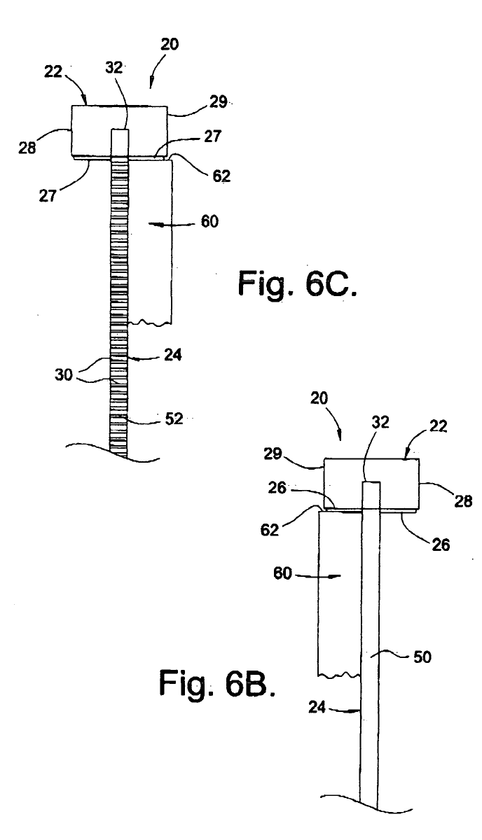

FIG. 1 shows the apparatus 20 of the invention. The apparatus 20 includes a head 22 attached to a body 24. Wheels 26, 27, rollers or the like (collectively “wheels”) are typically in pairs, and typically at least two per lateral side 28, 29 of the head 22. These paired wheels 26, 27 allow for the apparatus 20 to ride along the surface 62 of the planar material 60 being worked or operated on (FIGS. 6A-6C, 7, 8A and 8B). The body 24 includes notches 30 to facilitate temporary retention of a marking, scoring or cutting tool. The notches 30 are typically positioned at equidistant intervals.

The head 22 and body 24 are oriented at least substantially perpendicular, and typically perpendicular, with respect to each other. In the apparatus 20, for example, the transverse axis 31T, that extends through the head 22 of the apparatus 20, is oriented perpendicular to the longitudinal axis 31L, that extends through the head 22 and body 24 of the apparatus 20. The head 22 and body 24 are typically unitary members that are single pieces, but could also be formed of multiple pieces. Both the head 22, body 24 and wheels 27, 28 can be made of wood, plastics, rubbers, elastomers, metals or combinations thereof.

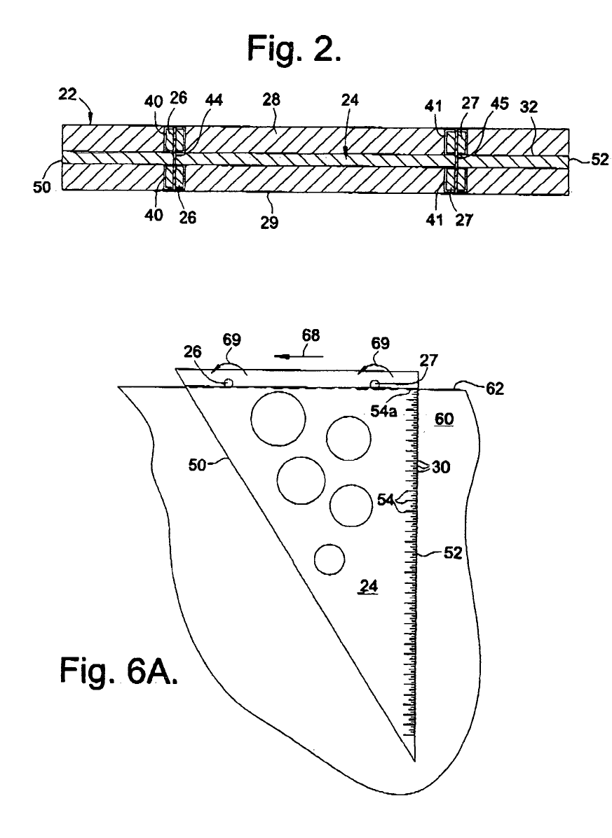

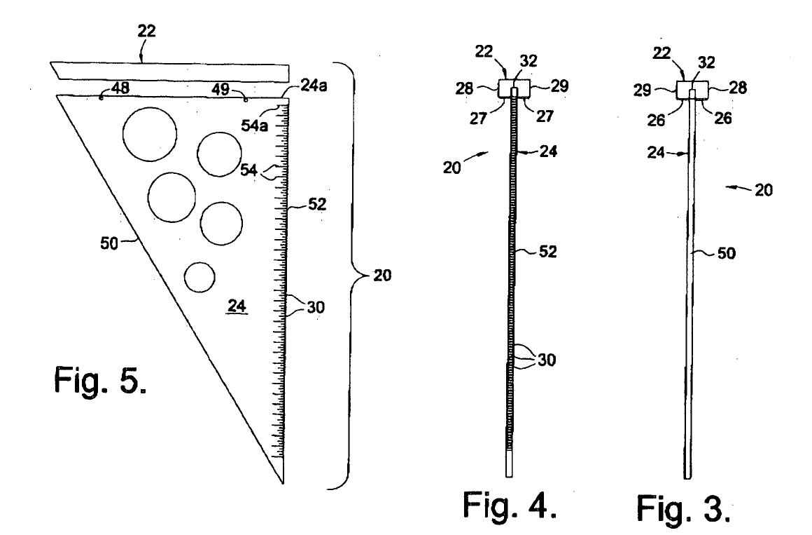

Turning also to FIGS. 2-5, the head 22 typically includes a slot 32, extending into the head 22, for receiving the body 24, or a protrusion extending from the body 24. This slot 32 is typically disposed intermediate the lateral sides 28, 29. This slot 32 is typically centrally positioned in the head 22, between the lateral sides 28, 29, and typically receives the body 24, as detailed below.

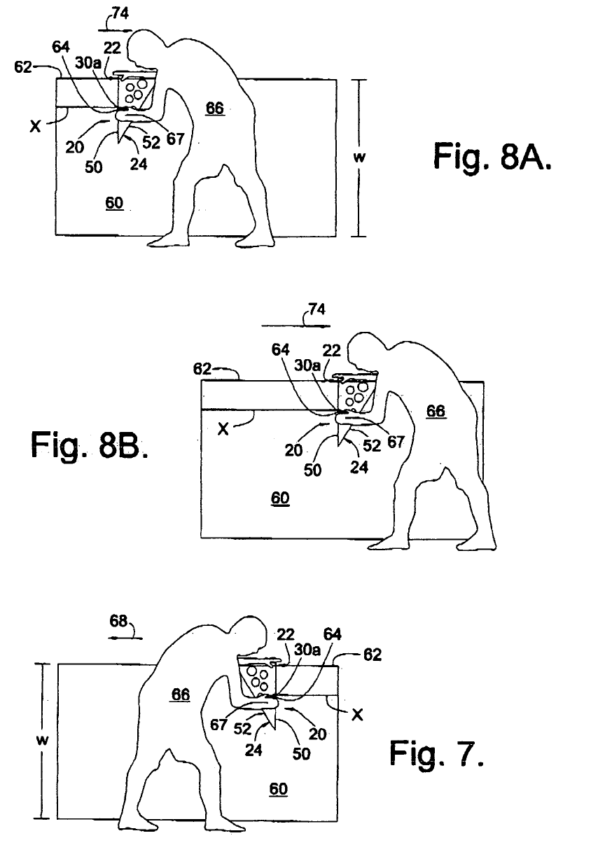

The lateral sides 28, 29 define guides, that extend over the planar material 60 (FIGS. 6A-6C) for the wheels 26, 27 to contact the planar material 60 for right-handed (FIGS. 6A-6C and 7) and left-handed FIGS. 8A and 8B) use of the apparatus 20. Wheel wells 40, 41 are cut into the lateral sides 28, 29 to accommodate the wheels 26, 27. The wheel wells 40, 41, are also paired, to accommodate the paired wheels 26, 27, both pairs of wheels 26, 27 rotating on common axles 44, 45, that extend through the head 22.

The wheels 26, 27 on each lateral side 28, 29 of the head 22, typically extend beyond the head 22. These wheels 26, 27 are typically positioned in the head 22, so that tangents to their lowest points, respectively, define a plane HH (shown by broken lines), that is typically parallel with the transverse axis 3 IT that extends through the head 22. This orientation of the plane HH for the wheels 26, 27 renders the wheels 26, 27 and the head 22, perpendicular to the longitudinal axis 31L of the apparatus 20, and accordingly, to the body 24.

While two pairs of wheels 26, 27 are shown, any number of paired wheels is suitable, provided that their tangential plane (corresponding to plane HH) is parallel to the transverse axis 31T of the head 22. Similarly, the wheels 26, 27 need not be paired on the lateral sides 28, 29 of the head 22, provided that their tangential plane (corresponding to plane HH) is parallel to the transverse axis 31T of the head 22.

The body 24 is typically triangular, for example, right triangular, in shape. The end 24a of the body 24, or a protrusion extending from it, is typically received in the slot 32 of the head 22 in a friction fit. This friction fit can be supplemented with adhesives, mechanical fasteners (for example, nails, screws, etc.) or combinations thereof. The aforementioned attachment of the body 24 to the head 22 can also be by adhesives, mechanical fasteners, or combinations thereof.

The body 24 also includes bores 48, 49), extending through the body 24 to accommodate the axles 44, 45 while keeping the wheels 26, 27 in their respective wells 40, 41. The axles 44, 45 are placed into the head 22 and through the bores 48, 49 in the body 24 by standard techniques. This configuration of the axles 44, 45 also serves to maintain the attachment of the body 24 to the head 22.

The body 24 typically includes a leading edge 50 and a trailing edge 52 (this orientation for the edges defined by a typical use as shown in FIGS. 6A-6C, 7, 8A and 8B). The trailing edge 52 is typically parallel to the longitudinal axis 31L and therefore, perpendicular to the transverse axis 31T (and the plane HH). The notches 30 extend along this trailing edge 52 and are indicated by indicia 54, typically marked or cut into the body 24. The notches 30 are typically are typically V-shaped. However, these notches 30 can be any other shape suitable for facilitating temporarily retention of at least one of a marking, cutting or scoring tool.

The indicia 54, corresponding to the notches 30, are typically at equidistant intervals. These intervals are, for example, 1/8 inch, 1/4 inch or the like, but can be at any interval or distance therebetween desired. For accuracy in measurement, the “zero” or origin indicia 54a is typically collinear (or coincident) with the plane HH formed by the wheels 26, 27. The body 24 may also include openings 58, for example, for facilitating additional markings, scorings, cuts, etc.

An example apparatus can be as follows. The apparatus can have a head 22 of dimensions, 2 inches by 1 inch by 16 inches. The slot 32 is typically 12 inch deep into the head 22, and can be of a width of 3/8 inches or slightly greater. The body 24, can be 3/8 inches thick, for seating within this slot 32. The apparatus can be of overall linear dimensions of 16 inches (along the head 22, parallel to the transverse axis 31T) by 26 inches (the trailing edge 52 including the head 22, parallel to the longitudinal axis 31L). The leading edge 50 (including the head 22) can be approximately 30.5 inches, and the angle between the leading edge 50 and the trailing edge 52 is approximately 31.5 degrees. In this example apparatus, the wheels 26, 27, on both lateral sides 26, 27, define a plane HH that is perpendicular to both the longitudinal axis 31L and the trailing edge 52. The wheels 26, 27, on both lateral sides 28, 29, are positioned in the head 22 to extend 1/16 of an inch beyond the head 22, so the plane HH formed by the tangents at the lowest points, respectively, is collinear with the “zero” or origin indicia 54a. The indicia 54 and corresponding notches 30 extend 24 inches from the “zero” 54a indicia along the trailing edge 52. This extra length toward the end of the body 24, extending beyond the notches 30 and corresponding indicia 54, opposite the end of the body 24 received in the head 22, allows for all 24 inches of notches 30 and corresponding indicia 54 to be usable for marking, cutting and/or scoring. Moreover, this arrangement allows for marking, scoring or cutting of at least half of the planar building material, which is typically of a standard dimension (width) (indicated by “w” on FIGS. 7 and 8A) of 48 inches. The indicia can be marked with two numbers, these numbers summing to 48, so as to represent the 48 inch standard dimension of the planar building material. Accordingly, the planar material can be marked, scored or cut to any desired size.

Turning also to FIGS. 6A-6C and 7, the apparatus 20 is shown in an exemplary operation, here, a right-handed operation. (In FIG. 6A, the material 60 is behind the apparatus 20). The planar material 60 (of width w) to be worked is held or supported upright. The apparatus 20 is now brought into contact with the planar material 60, such that one of the lateral sides 28, 29, here the lateral side 29 rests over the top of the material 60. The wheels 26, 27 are now in contact with the top surface 62 of the planar material 60. A tool or instrument 64, for any one of marking, scoring or cutting, is placed into the desired notch 30. Here, for example, the notch 30a is shown for receiving the tool or instrument 64. The user 66, typically with his fingers 67, places the tool 64 into the notch 30a. While holding the tool 64 in the notch 30a, the apparatus 20 is moved in the direction of the arrow 68.

Movement is such that the wheels 26, 27 remain in contact with top surface 62 of the planar material 60, and the tool 64 remains pressed and retained in the notch 30a. Movement of the apparatus 20 (in the direction of the arrow 68, with the wheels 26, 27 rotating in accordance with the arrows 69), coupled with the tool 64 in contact with the planar material 60, and retained in the notch 30a, results in a continuous (or non-continuous, if the tool 64 is taken out of contact with the material 60, if desired) mark, score or cut (indicated by X) in the planar material 60, for the distance that the apparatus 20 is moved. This process can be repeated for as many times as desired, until the material 60 has been marked, scored, or cut as desired.

FIGS. 8A and 8B also show the apparatus 20 in an exemplary operation, and in particular a left-handed use or operation. This operation is similar in all aspects to right handed operation for the apparatus 20, as detailed above, and is numbered similarly, except where indicated. This left-handed operation is different from the above-described right-handed operation, for it is opposite. Accordingly, the lateral side 28 contacts the top surface 62 of the planar material 60 (of width w) and the apparatus 20 is moved in the direction of the arrow 74 (opposite the direction of the arrow 68).

While the apparatus 20 is symmetric with respect to its transverse axis 31T, alternate embodiments can be asymmetric. These alternate embodiments can have one lateral side 28, 29, typically with at least two wheels 26, 27, this single side serving as a guide. The lateral side having the wheels would determine if the alternate embodiment were an apparatus for right-handed or left-handed use.

Alternate embodiments of the apparatus can also be of a head 22, that is formed of multiple pieces. In one alternate embodiment, two side members, defining the lateral sides 28, 29 for containing the wheels, are joined to the body at its top portion. Still alternately, two side members, defining the lateral sides 28, 29 for containing the wheels 26, 27, are joined to the top portion of the body and a capping member or members are placed (and attached) over the side members and the body. In another alternate embodiment, the head can be formed of two L-shaped pieces (with wheel wells 40, 41 to define the lateral sides 28, 29), that when brought together define the slot 32. The body 24 can be placed into the slot 32 and all of the pieces are joined together. In all of these alternate embodiments, the wheels 26, 27 and their axles 44, 45 are placed into the apparatus by standard techniques.

There has been shown and described at least one preferred embodiment of an apparatus for marking, scoring and/or cutting planar materials. It is apparent to those skilled in the art, however, that many changes, variations, modifications, and other uses and applications for the apparatus and its components are possible, and also such changes, variations, modifications, and other uses and applications which do not depart from the spirit and scope of the invention are deemed to be covered by the invention, which is limited only by the claims which follow.

What is claimed is:

1. An apparatus for operating on at least substantially planar materials comprising:
a body having at least one edge configured for temporarily accommodating instrumentation for at least one of marking, cutting or scoring;
a head in communication with the body, the head including at least one lateral portion extending beyond the body; and
at least two rollers along the at least one lateral portion, the rollers oriented substantially coplanar to each other to define a first plane.

2. The apparatus of claim 1, wherein the body is oriented substantially perpendicular to the first plane defined by the rollers.

3. The apparatus of claim 2, wherein the body is attached to the head.

4. The apparatus of claim 1, wherein the at least two rollers include wheels.

5. The apparatus of claim 1, wherein the at least one lateral portion includes two lateral portions of the head extending beyond the body.

6. The apparatus of claim 5, wherein the two lateral portions are oppositely disposed with respect to each other.

7. The apparatus of claim 6, wherein the at least two rollers include wheels.

8. The apparatus of claim 1, wherein the body configured at a plurality of positions for temporarily accommodating instrumentation for at least one of marking, cutting or scoring, includes a plurality of notches cut into the at least one edge of the body.

9. The apparatus of claim 1, wherein the at least two rollers each extend beyond the head.

10. The apparatus of claim 8, wherein the body includes indicia corresponding to each of the notches cut into the at least one edge.

11. The apparatus of claim 10, wherein the indicia are proximate to the at least one edge.

12. The apparatus of claim 1, wherein the at least one edge configured for temporarily accommodating instrumentation for at least one of marking, cutting or scoring, includes one edge.

13. An apparatus for operating on at least substantially planar materials comprising:
a body having at least one edge configured for temporarily accommodating instrumentation for at least one of marking, cutting or scoring;
a head attached to at least a portion of body, the head including at least one lateral portion extending beyond the body; and
at least two rollers along the at least one lateral portion, the rollers oriented substantially coplanar to each other to define a first plane.

14. The apparatus of claim 13, wherein the head includes a slot for receiving the body, the slot proximate to the at least one lateral portion.

15. The apparatus of claim 13, wherein the body is oriented substantially perpendicular to the first plane defined by the rollers.

16. The apparatus of claim 13, wherein the at least two rollers include wheels.

17. The apparatus of claim 13, wherein the at least one lateral portion includes two lateral portions of the head extending beyond the body.

18. The apparatus of claim 17, wherein the slot is intermediate the two lateral portions.

19. The apparatus of claim 17, wherein the at least two rollers include wheels.

20. The apparatus of claim 13, wherein the body configured at a plurality of positions for temporarily accommodating instrumentation for at least one of marking, cutting or scoring, includes a plurality of notches cut into the at least one edge of the body.

21. The apparatus of claim 19, wherein the at least two rollers each extend beyond the head.

22. The apparatus of claim 20, wherein the body includes indicia corresponding to each of the notches cut into the at least one edge.

23. The apparatus of claim 22, wherein the indicia are proximate to the at least one edge.

24. The apparatus of claim 13, wherein the at least one edge configured for temporarily accommodating instrumentation for at least one of marking, cutting or scoring, includes one edge.

25. A method for operating on at least substantially planar materials comprising:
providing an apparatus comprising:
a body having at least one notch along an edge, the notch for temporarily accommodating instrumentation for at least one of marking, cutting or scoring;
a head in communication with the body, the head including at least one lateral portion extending beyond the body; and
at least two rollers along the at least one lateral portion, the rollers oriented substantially coplanar to each other to define a roller plane, the roller plane at least substantially perpendicular to a plane defined by the edge of the body including the at least one notch;
placing the rollers of the at least one lateral portion into contact with the top surface of an at least substantially planar material;
providing an instrument into the at least one notch; and
moving the apparatus along the top surface of the at least substantially planar material.

26. The method of claim 25, wherein moving the apparatus along the top surface includes the maintenance of contact between the rollers and the top surface.

27. The method of claim 25, wherein the instrument includes a marking tool.

28. The method of claim 25, wherein the instrument includes a scoring tool.

29. The method of claim 25, wherein the instrument includes a cutting tool.
